(19) United States
(12) Patent Application Publication
(10) Pub. No.: US 2005/0179278 A1
(43) Pub. Date: Aug. 18, 2005

(54) Single or dual flush floor upper deck slide-out

(76) Inventor: Carl Yoder, Millersburg, IN (US)

Correspondence Address: DARBY & DARBY P.C., P. O. BOX 5257, NEW YORK, NY, 10150-5257, US

(21) Appl. No.: 10/988,483

(22) Filed: Nov. 12, 2004

Related U.S. Application Data
(60) Provisional application No. 60/519,976, filed on Nov. 14, 2003.

(51) Int. Cl. B60P 3/34

(52) U.S. Cl. 296/26.13; 296/26.01

(57) ABSTRACT

A slide-out mechanism for a vehicle is provided to extend and retract at least one slide-out section relative to a frame of the vehicle. The slide-out section has a floor and is configured for incorporation into a chassis of the vehicle and includes (a) a frame; (b) a plurality of movable arms supported by the frame and having ends that are securely coupled to the floor of the slide-out section, wherein at least one of the movable arms is a drive arm; and (c) drive means coupled to an intermediate section of the drive arm for driving the drive arm in a first direction for extending the movable arm outwardly from the frame resulting in the slide-out section being driven to an extended position and a second direction for retracting the movable arm toward the frame resulting in the slide-out section being driven to a retracted position.

### CROSS-REFERENCE TO RELATED APPLICATION

This application claims the benefit of U.S. patent application Ser. No. 60/519,976, filed Nov. 14, 2003, and is related to U.S. patent application Ser. No. 10/______, filed concurrently herewith and entitled “SLIDE-OUT MECHANISM FOR USE IN A VEHICLE”, which claims the benefit of U.S. patent application Ser. No. 60/520,241, all of which are hereby incorporated by reference in their entirety.

### TECHNICAL FIELD

The present invention relates to vehicles with one or more moveable room sections, and more particularly, relates to a slide-out mechanism that moves the moveable room section in a controlled manner from a retracted position relative to a main housing of the vehicle to an extended position where the moveable room protrudes beyond the main housing.

### BACKGROUND

Conventional recreational vehicles (RV) are available in a number of different types depending upon the size requirements and other desires of the purchaser. For example, the purchaser or user can select an RV that is motorized and can be driven by itself or one can be selected that requires a tow vehicle to tow the RV. Consumers increasingly want additional, increased interior room and also want to be provided with additional options available with the RV. One option that has found increasing commonality in the recent years is the incorporation of one or more slide-out sections into the RV. The slide-out sections are part of an automated system where the user simply activates the system resulting in the slide-out section extending outward from an exterior wall of the RV. The slide-out section in its extended position thus increases the overall available interior space. Slide-out sections can be incorporated into any number of different types of RVs including motor homes and fifth wheel trailer type RVs.

With respect to a fifth wheel type RV, the upper deck portion is typically used as a living area and therefore, the incorporation of a slide-out section in the upper deck portion is desirable since it results in an increase in the available space for use as a living area. However, it is difficult to incorporate conventional slide-out mechanisms into the upper deck of a fifth wheel trailer. In conventional recreational vehicles, the operating mechanism is stored in the front or rear section of the slide-out mechanism. However, in the case of a slide-out mechanism in the upper deck, the operating mechanism would be blocked by the fifth wheel equipment if the slide-out mechanism was placed in front. Access to the operating mechanism would be difficult since it would be necessary to remove the fifth wheel to access the operating mechanism. Thus, these constraints make it difficult for the slide-out mechanism to be incorporated into the fifth wheel section.

In conventional recreational vehicles, the slide-out mechanism is many times incorporated above the floor of the vehicle since it is difficult to integrate the slide-out mechanism into the chassis. It is also difficult to integrate the slide-out mechanism into the chassis in a way that maintains a pleasing appearance for the vehicle. As a result, the slide-out mechanism is typically placed above the floor location; however, by incorporating the slide-out mechanism above the floor of the upper deck, the amount of available interior space in the upper deck decreases and thus, it is somewhat counterproductive to place the mechanism at this location.

Conventional recreational vehicles typically include slide-out mechanisms with one or two arms that are the drive means for driving the slide-out section. However, slide-out mechanisms including only one arm provide limited support and are less stable. For slide-out mechanisms including multiple arms, the movement of the arms must be synchronized. Arms that are not synchronized cause the slide-out section to be misaligned during expansion which can damage the slide-out mechanism and spoil the outward appearance of the vehicle.

Conventional recreational vehicles with slide-out mechanisms also typically include a main floor section and moveable floor sections. In the retracted position, the moveable floor sections lie on top of the main floor section. In the extended position, the moveable floor sections slide outward with respect to the main floor section. However, the height differential between the moveable floor sections and the main floor sections creates a step that is a potential safety hazard and detracts from the appearance of the room.

### SUMMARY

It is one object of the present invention to provide a slide-out mechanism for the upper deck that is integrated into the chassis, has excellent structural integrity, and has at least three arms that are synchronized when the mechanism is actuated and the arms are extended. The slide-out mechanism also provides an aesthetically attractive appearance in its extended and retracted positions. Another object of the present invention is to provide a slide-out mechanism for providing a moveable room section whose floor is aligned flush with the floor of the stationary room section.

The aforementioned objects are achieved by providing a slide-out mechanism for a vehicle to extend and retract at least one slide-out section relative to a frame of the vehicle. The slide-out section has a floor and is configured for incorporation into a chassis of the vehicle and includes (a) a frame; (b) a plurality of movable arms supported by the frame and having ends that are securely coupled to the floor of the slide-out section, wherein at least one of the movable arms is a drive arm; and (c) drive means coupled to an intermediate section of the drive arm for driving the drive arm in a first direction for extending the movable arm outwardly from the frame resulting in the slide-out section being driven to an extended position and a second direction for retracting the movable arm toward the frame resulting in the slide-out section being driven to a retracted position.

It will be appreciated that the present slide-out mechanism can be incorporated into a chassis associated with any number of different types of vehicles, such as motor homes and trailer type vehicles.

In one embodiment, a fifth wheel type recreational vehicle is provided and includes a main cabin portion and an upper deck portion having a chassis that supports a stationary base floor and a slide-out section that includes a floor and selectively extends from an exterior surface when actuated for increasing an interior space of the upper deck portion. The vehicle includes a slide-out mechanism for selectively moving the slide-out section between a retracted position and an extended position, with the mechanism being nested within receiving features that are formed in the chassis so as to couple the mechanism to the chassis. The mechanism is disposed underneath the stationary base floor and includes: (a) a frame that is securely attached to the chassis; (b) at least three hollow support members that have first ends that are securely coupled to the frame and second ends that are nested within the receiving features of the chassis, with at least one of the hollow support members having an elongated slot formed in a face thereof; (c) at least three arms that are slidably received within the hollow support members with each having one end thereof that is securely connected to the overlying floor of the slide-out section such that movement of the arm is translated into movement of the arms is translated into movement of the floor of the slide-out section, wherein at least of the arms is a drive arm; (d) a drive device that is selectively operable and includes an elongated drive piston that extends through the elongated slot and is coupled at one end to a medial region of the drive arm; wherein extension of the drive piston is translated into extension of the drive arm outwardly beyond the chassis resulting in the slide-out section moving from a retracted position where it overlies the stationary floor to an extended position where the floor of the slide-out section is substantially flush with the stationary floor and when the drive piston is retracted, the drive arm is likewise retracted causing the slide-out section to be drawn back to the retracted position; and (e) a ramp structure that cooperates with the stationary floor and is coupled to the chassis to permit the floor of the slide-out section to ride down the ramp structure as the floor is moved from the retracted position to the extended position and vice versa when the floor is driven back to the retracted position.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements and in which:

FIG. 1 is a perspective view of a fifth wheel RV with slide-out section in the upper deck according to an embodiment of the present invention;

FIG. 2 is an exploded perspective view of an upper deck portion of a chassis and a slide-out mechanism according to an embodiment of the present invention;

FIG. 3 is a perspective view of a slide-out mechanism mounted onto an upper deck portion of the chassis according to an embodiment of the present invention;

FIG. 4 is a cutaway view taken along line 4 of FIG. 2 showing the connection between a stub on a side frame member and a rear support member;

FIG. 5 is a cutaway view taken along line 5 of FIG. 2 showing wear tabs positioned on a rear support member;

FIG. 6 is a cutaway view taken along line 6-6 of FIG. 2 of a middle telescoping arm in the retracted position inside a middle support member;

FIG. 7 is a side view of a middle telescoping arm moving to the extended position inside a middle support member;

FIG. 8 is a perspective view of the interior space of a fifth wheel RV when a slide-out section is in the retracted position;

FIG. 9 is a perspective view of the interior space of a fifth wheel RV when a slide-out section is in the extended position;

FIG. 10 is a cutaway view taken along the line 10-10 of FIG. 8 of a moveable floor when a slide-out section is in the retracted position;

FIG. 11 is a cutaway view taken along the line 11-11 of FIG. 9 of a moveable floor when a slide-out section is in the extended position;

FIG. 12 is a perspective view of a center support sub-assembly of an alternate embodiment of the present invention;

FIG. 13 is a perspective view of a passive support sub-assembly of an alternate embodiment of the present invention;

FIG. 14 is a perspective view of a center support sub-assembly and a rack-and-pinion mechanism of an alternate embodiment of the present invention;

FIG. 15 is a perspective view of a gear mechanism of the rack-and-pinion mechanism of FIG. 14;

FIG. 16 is a cutaway side view of the center support sub-assembly and the rack-and-pinion mechanism of FIG. 14; and

FIG. 17 is a side view of a middle arm and middle support member of the center support sub-assembly of FIGS. 15 and 16.

### DETAILED DESCRIPTION OF THE EMBODIMENTS

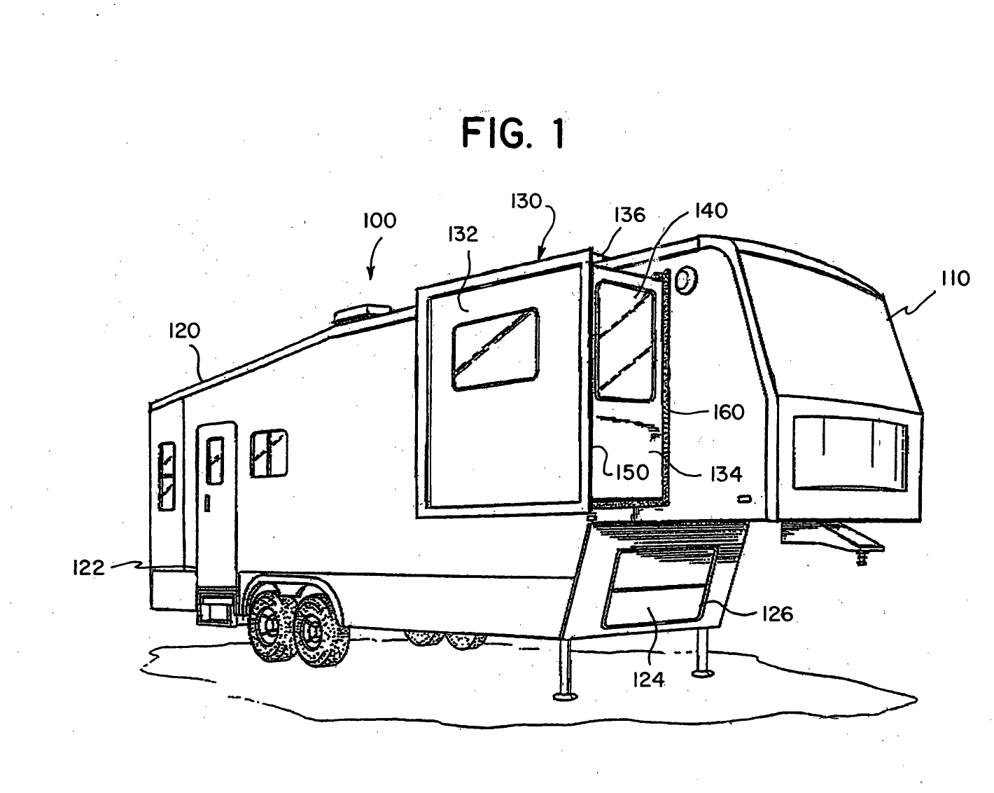

FIG. 1 is a perspective view of one exemplary recreational vehicle (RV) 100. There are a number of different types of RVs that are available to a user depending upon a particular individual's needs, desires and wishes. For example, one type of RV is a motor home that is a self-contained motorized RV that looks something like a bus and is often referred to as a “coach”. This type of RV includes a number of different rooms and amenities that can provide superior comfort. Another type of RV is a travel trailer that is designed to be towed by a vehicle having hitch equipment for securely mating with the frame of the tow vehicle. Yet another type of RV is called a fifth wheel trailer (often referred to as a “fifth wheel”) which is a trailer that is designed to be towed by a vehicle, such as a pickup truck, that is equipped with a special hitch in a bed portion of the tow vehicle. FIG. 1 illustrates a fifth wheel type RV 100; however, it will be understood that the present invention is not limited to fifth wheel type RVs but rather it can be incorporated into other types of RVs, including those mentioned above. The fifth wheel type RV 100 is easily distinguished by its neck portion 110, which is also called an upper deck portion of the RV 100, that is formed at the front of the RV 100. Often times, this upper deck portion 110 houses a living room. To the rear of the upper deck portion 110, a main cabin or housing 120 is provided and extends completely to the rear of the RV 100 and typically includes additional rooms, such as a master bedroom, kitchen, bathroom, etc. A door 122 for entering the interior of the main cabin 120 is provided in this section.

In most, if not all, of the RVs mentioned above, one or more slide-out sections 130 can be provided which, when extended, provide an increased amount of interior space. For example, the exemplary fifth wheel RV 100 of FIG. 1 has at least one and preferably two slide-out sections 130 which are controllably movable from a retracted position to an extended position (shown in FIG. 1) for the purpose of increasing the available interior space of the RV 100. By actuating a slide-out mechanism, described in greater detail hereinafter, one or more sections of an exterior wall 132 of the RV can be extended away from the surrounding exterior wall. As shown in FIG. 1, the slide-out section 130 contains not only the exterior wall section 132 but also has a pair of side walls 134 as well as a roof section 136. One or more windows 140 can be incorporated into the slide-out section 130 as well. In order to provide a seal against the elements in both the retracted and extended positions, a skirt 150 can be provided around the exterior wall section 132 and a seal element 160 can be provided around the opening formed in the surrounding exterior wall that permits the extension and retraction of the slide-out section 130. When the slide-out section 130 is retracted, the skirt 150 preferably is in intimate contact with the seal element 160 to effectively seal the interior of the RV 100. The seal element 160 can be formed of any number of conventional sealing materials, such as a suitable insulation, etc. In addition, another seal element (not shown) can be provided on an underside of the skirt 150.

Below the upper deck portion 110 toward the front of the RV 100, a storage compartment 124 can be provided. The interior of the storage compartment 124 can be accessed via a door 126 provided at the front or on one or both of the sides of the storage compartment 124.

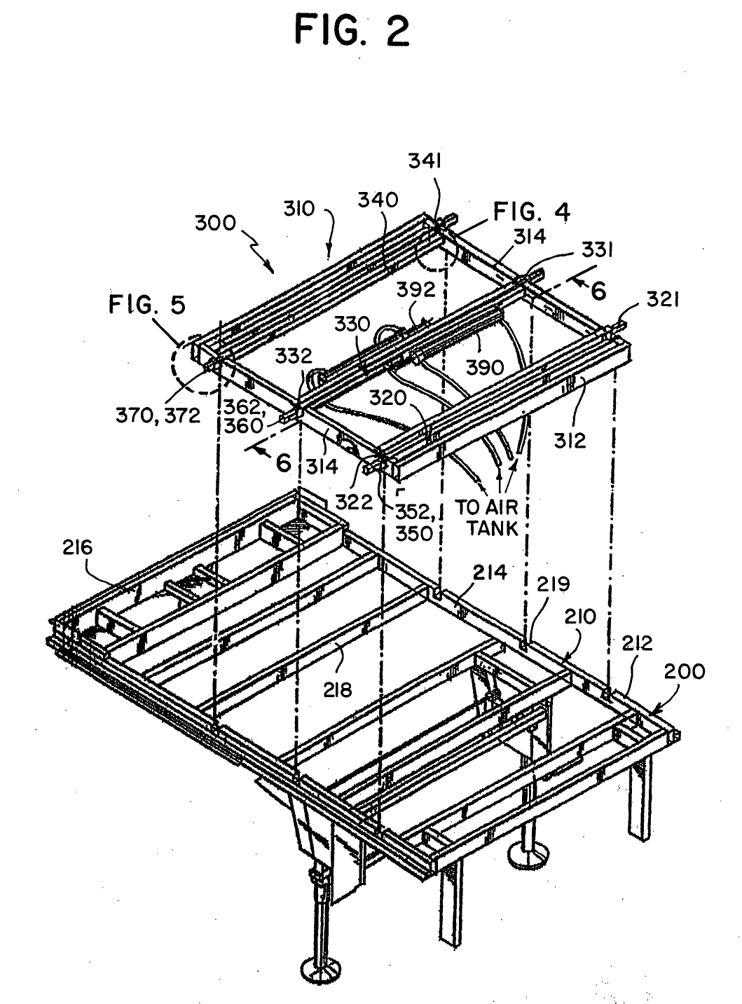

As shown in FIG. 2, the RV 100 includes a structural frame in the form of a chassis 200 that supports the upper deck portion 110 and the main cabin 120. The chassis 200 includes an upper deck portion 210 and a main cabin portion (not shown). The upper deck portion 210 of the chassis 200 supports the upper deck portion 110 of the RV 100.

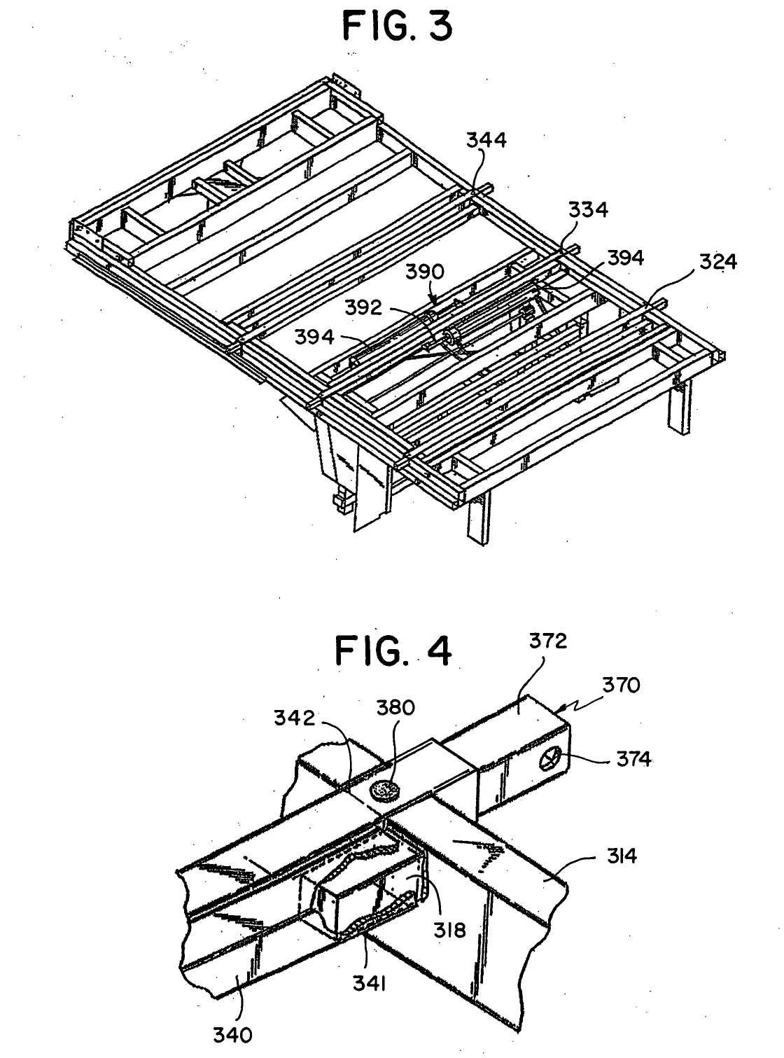

FIG. 2 is an exploded perspective view of a slide-out mechanism 300 which is mounted onto and incorporated into the upper deck portion 210 of the chassis 200, and FIG. 3 is a perspective view of the slide-out mechanism 300 mounted onto the upper deck portion 210 of the chassis 200 according to an embodiment of the present invention. The slide-out mechanism 300 helps to enable the slide-out section 130 of the RV 100 to move between the retracted position and the extended position shown in FIG. 1. The slide-out mechanism 300 of the present invention, however, is not limited to being placed in the upper deck portion 210 of the chassis 200 and can be used in combination with slide-out sections 130 in other areas of the RV 100, such as in the main cabin 120. The upper deck portion 210 of the chassis 200 is constructed in a conventional manner in that it includes a plurality of structural support members 212 that are arranged and coupled to one another to provide a support platform for the upper deck portion 110 of the RV 100. For example, the upper deck portion 210 can include side frame members 214 that are spaced apart from one another; end frame members 216; and a plurality of cross support member 218 that are securely coupled at their ends to the side frame members 214. Each of the side frame members 214 includes a plurality of spaced notches 219 formed therein at pre-selected locations. The function of the notches 219 will be described hereinafter. The notches 219 can be formed to have any number of shapes and according to the illustrated embodiment, the notches 219 are U or C-shaped in construction. The number of notches 219 will vary on the construction of the slide-out mechanism 300 and in one exemplary embodiment (as illustrated), there are three notches 219 in each of the side frame members 214 with one notch 219 being axially aligned with one corresponding notch 219 on the other side frame member 214. The frame members of the chassis 200 are typically metal support beams that can be solid or hollow in construction.

The slide-out mechanism 300 functions as a mechanical drive mechanism for causing the controlled extension and retraction of the slide-out sections 130. The slide-out mechanism 300 can be configured to drive a single slide-out section 130 or it can be configured to drive two slide-out sections 130 as in the illustrated embodiment, and thus can be referred to as a dual slide-out drive mechanism.

The slide-out mechanism 300 includes a base frame 310 that is complementary to the upper deck portion 210 of the chassis 200 so that the base frame 310 can be mated therewith, resulting in the frame 310 being supported by the upper deck portion 210. The base frame 310 is securely attached to the upper deck portion 210 of the chassis 200 using conventional techniques, such as a welding process where the interfaces between the two are securely welded to one another. In other words, welds are formed, for example, between the surfaces of the chassis 200 (upper deck portion 210) and the frame 310 which are in contact.

The exemplary frame 310 has a square shape (box) or can be rectangular shaped and is formed of a front frame member 312, two side frame members 314, and a rear frame member 316. The frame members 312, 314, 316 are connected at their ends to each other so as to form a rigid support frame and typically, the frame members 312, 314, 316 are formed of metal materials and can either be solid or hollow in construction. In the illustrated embodiment, each of the frame members 312, 314, 316 is a hollow member with a substantially rectangular cross-sectional shape and therefore, can be thought of as tubular support member. It will be appreciated that the frame members 312, 314, 316 can be formed in any number of different shapes so long as the members 312, 314, 316 are compatible with the upper deck portion 210 of the frame 200.

The frame 310 further includes a plurality of cross support members, namely, two front support members 320, two middle support members 330, and two rear support members 340. Each front support member 320 includes a first end 321 and a second end 322; the middle support member 330 includes a first end 331 and a second end 332; and the rear support member 340 includes a first end 341 and a second end 342. The support members 320, 330, 340 are very similar, if not identical, to one another and they have substantially identical outer dimensions and lie parallel to each other when they are coupled to the side frame members 314.

The two front support members 320 are positioned proximate to each other toward the front frame member 312 at the front of the frame 310, and the two rear support members 340 are positioned proximate to each other toward the rear frame member 316 at the rear of the frame 310. The front support members 320 are preferably substantially identical to the rear support members 340. The middle support members 330 are coupled to one another and are positioned side-by-side near the middle of the frame 310.

The support members 320, 330, 340 are generally hollow members that receive a plurality of telescoping arms 350, 360, 370, respectively, as described below. The first ends 321, 331, 341 of the support members 320, 330, 340 are slidably connected to one of the side frame members 314 such that while the first ends 321, 331, 341 are securely coupled thereto, the support members 320, 330, 340 are permitted a limited degree of travel. For example, an inner surface of the side members 314 can include a plurality of spaced protrusions, posts or stubs 318 that are received with the first ends 321, 331, 341. The protrusions 318 thus have a complementary shape and are dimensioned so that they can be received within the support members 320, 330, 340. Thus, the illustrated protrusions 318 have a generally rectangular or square cross-section.

The plurality of telescoping arms 350, 360, 370 are mounted at positions spaced apart along the length of the side frame members 314. Front telescoping arms 350 and rear telescoping arms 370 are slidably supported within the front support members 320 and the rear support members 340, respectively. The front telescoping arms 350 are substantially identical to the rear telescoping arms 370. A middle telescoping arm 360 is slidably supported within the middle support member 330. In an embodiment of the present invention, the frame members 312, 314, 316, the support members 320, 330, 340 and the arms 350, 360, 370 are tubular, as shown in FIGS. 1-11.

The front telescoping arm 350 includes a first end 351 and a second end 352; the middle telescoping arm 360 includes a first end 361 and a second end 362; and the rear telescoping arm 370 includes a first end 371 and a second end 372. The telescoping arms 350, 360, 370 have substantially identical outer dimensions since the inner dimensions of the support members 320, 330, 340 are substantially identical. The first ends 351, 361, 371 of the telescoping arms 350, 360, 370 are free to slide within their respective support members 320, 330, 340. The second ends 352, 362, 372 of the telescoping arms 350, 360, 370 extend beyond the second ends of the support members 320, 330, 340.

The support members 320, 330, 340 and telescoping arms 350, 360, 370 are aligned such that their length in the longitudinal direction is parallel to the direction of expansion or retraction of the slide-out section 130 across the width of the RV 100. The telescoping arms 350, 360, 370 are configured so that three arms 350, 360, 370 are capable of extending telescopically from each of the sides of the frame 310 when the mechanism 300 is actuated as described below.

The second ends 322, 332, 342 of the support members 320, 330, 340 are disposed within the plurality of notches 319 in the frame 310 and the plurality of notches 219 (shown in FIG. 2) in the upper deck portion 210 of the chassis 200 when the slide-out mechanism 300 is securely mounted to the chassis 200. In other words, and as will be described herein, the notches 319 in the frame 310 are substantially aligned with the notches 219 in the chassis 200 when the slide-out mechanism 300 is incorporated into the chassis 200.

The notches 219, 319 are formed in a U-shape and are cut away from the top surface of the side frame members 316 and the upper deck portion 210 of the chassis 200. Each notch 219, 319 has dimensions which are slightly larger than the outer dimensions of the support members 320, 330, 340 to permit a snug fit therebetween. The support members 320, 330, 340 sit and slide inside the notches 219, 319. The notches 219, 319 are positioned so that the support members 320, 330, 340 are aligned with the direction of expansion or retraction of the slide-out section 130 of the RV 100.

FIG. 4 is a cutaway view taken along circle 4 of FIG. 2 showing the connection between the rear support member 340 and the stub 318 on the side frame member 314. The first ends 321, 331, 341 of the support members 320, 330, 340 are slidably coupled to one of the side frame members 314 via the stubs 318. The stub 318 is fastened to the inward-facing vertical surface of the side frame member 314 by a method such as welding or the stub 318 can be formed integral thereto as during a molding process. The stub 318 can be formed solid or tubular.

Each of the side frame members 314 includes two stubs 318 on the inward-facing vertical surface thereof. The stubs 318 are coupled to and aligned with the front support members 320 and rear support members 340. The outer dimensions of the stub 318 are slightly smaller than the inner dimensions of the front support members 320 and rear support members 340 so that the first ends 321, 341 of the front and rear support members 320, 340 fit around the stub 318. This coupling forms a sliding connection that allows the front and rear support members 320, 340 to slide with respect to the stub 318 and the frame 310. This sliding motion is limited by the length of the stub 318. This sliding connection is formed between the first ends 321, 341 of the front and rear support members 320, 340 to the respective side frame members 314 via the stubs 318. Thus, since the front and rear support members 320, 340 are not fixedly attached to the frame 310, the front and rear support members 320, 340 are able to find their equilibrium by sliding freely with respect to the frame 310, thereby increasing the stability of the structure.

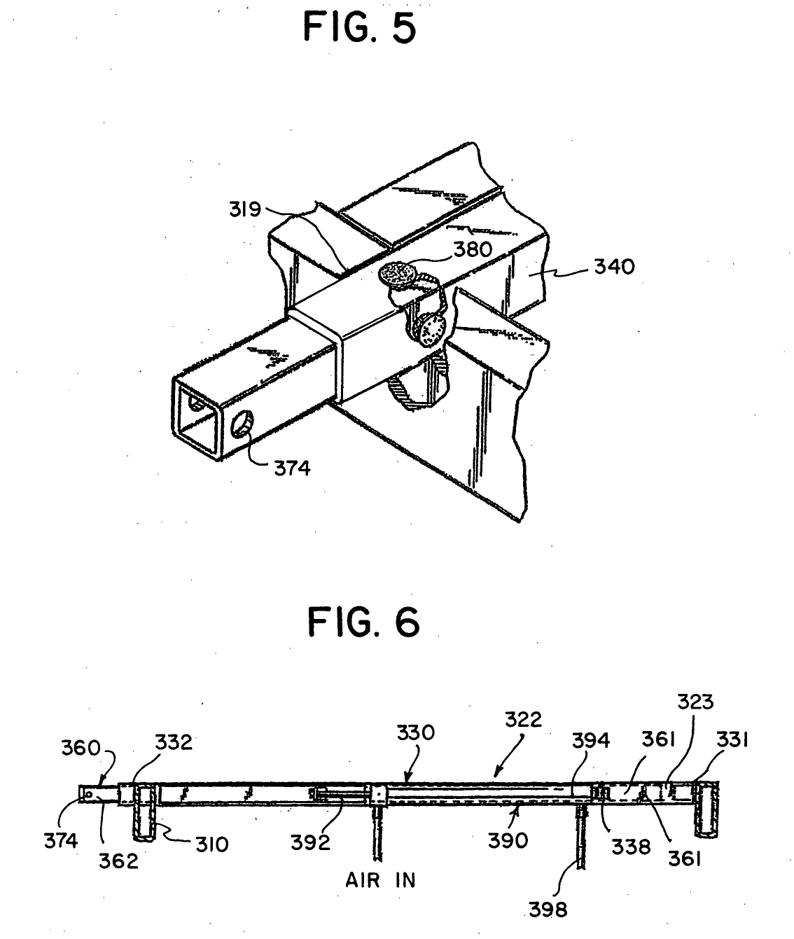

In one embodiment of the present invention, wear tabs 380 are provided on the arms 350, 360, 370 and the support members 320, 330, 340 to facilitate movement of the arms 350, 360, 370 inside the support members 320, 330, 340 and to protect the inside surfaces of the support members 320, 330, 340 and the outside surfaces of the arms 350, 360, 370. FIG. 5 is a cutaway view taken along circle 5 of FIG. 2 showing wear tabs 380 positioned on the rear support member 340.

Openings 324, 334, 344 for fastening the wear tabs 380 are disposed on the top and side surfaces of the respective second ends 322, 332, 342 of the support members 320, 330, 340 that protrude from the frame 310. Wear tabs 380 are also fastened to openings (not shown) provided on the top and side surfaces of the first ends 351, 361, 371 of the arms 350, 360, 370. Therefore, wear tabs 380 are provided on each of the interfaces between the top and side surfaces where the first ends 351, 361, 371 of the arms 350, 360, 370 slide inside the respective support members 320, 330, 340 and where the second ends 322, 332, 342 of the support members 320, 330, 340 support the arms 350, 360, 370 as they slide therein. Each wear tab 380 is positioned to contact the inner surface of the support member 320, 330, 340 and the outer surface of the arm 350, 360, 370. The wear tabs 380 are positioned only on the upper and side interfaces between the arm 350, 360, 370 and the support member 320, 330, 340 to help to protect the opposing surfaces of the support members and arms against damage, such as by scratching or abrasion, to the opposing surfaces of the arm and the support member.

FIG. 6 is a cutaway view taken along line 6-6 of FIG. 2 of one middle telescoping arm 360 in a retracted position inside one middle support member 330. The first end 331 of each middle support member 330 is fixedly supported by one side frame member 314, e.g., by welding, and is slidably supported by the notches 319 on the other side frame member 314 and by the notches 219 in the chassis 200. The two middle support members 330 are attached to each other in the middle of the frame 310 between the front support members 330 and the rear support members 340.

Each of the middle support members 330 includes a vertical surface or face 335 that faces away from the other middle support member 330. Thus, the vertical surface 335 in the middle support member 330 toward the front of the RV 100 faces the front of the RV 100, and the vertical surface 335 in the middle support member 330 toward the rear of the RV 100 faces the rear of the RV 100. A longitudinal slot 336 extends through the vertical surface 335 of the middle support member 330. As will be appreciated, the length of the longitudinal slot 336 defines the distance that the middle telescoping arm 360 can be driven as is described in detail hereinafter. The longer the longitudinal slot 336, the greater the distance that the middle telescoping arm 360 can be driven. The illustrated longitudinal slot 336 is rectangular shaped.

The middle support member 330 supports the middle arm 360 which slides therein, and the second end 362 of the middle arm 360 protrudes beyond the end of the middle support member 330. It is the telescoping arms 350, 360, 370 that support and permit the extension and retraction drive movements of the slide-out section 130.

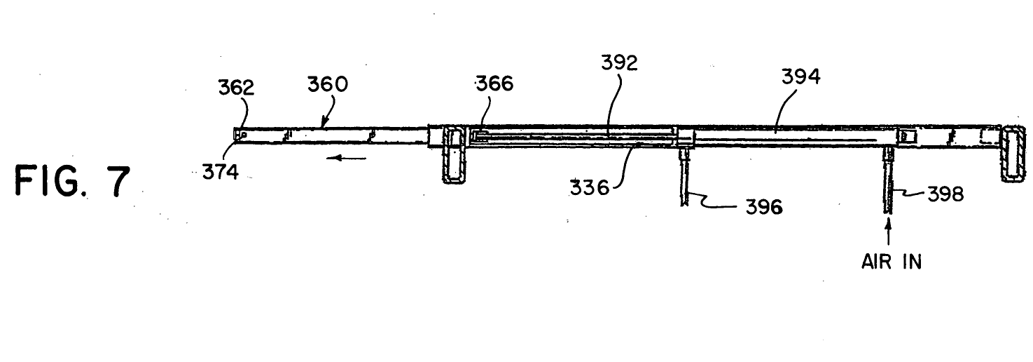

FIG. 6 shows the middle arm 360 in the retracted position, and FIG. 7 shows the middle arm 360 moving to the extended position. It will be appreciated that even when the middle arm 360 is driven to its extended position, a substantial length of the middle arm 360 remains within the middle support member 330. The mechanism 300 includes an operating mechanism 390 (shown in FIGS. 6 and 7) that includes a pair of drive shafts 392 which transfer motion from the operating mechanism 390 to the respective middle arms 360 to cause the extension or retraction of the middle arms 360.

Actuation of the operating mechanism 390 causes movement of the drive shaft 392 and since one end of the drive shaft 392 is coupled to one of the middle arms 360, the driving action is translated to the middle arm 360. The longitudinal slot 336 permits access to the middle arm 360 so that the shaft 392 can be coupled to a medial section of the middle arm 360. The slot 336 in the middle support member 330 allows the shaft 392 and the middle arm 360 to slide with respect to the middle support member 330 as the shaft 392 is driven. More specifically, the length of the slot 336 in the middle support member 330 enables the shaft 392 to access the middle arm 360 while the slide-out section 130 is in the extended or retracted positions. One stroke of the operating mechanism 390 slides the middle arm 360 in and out of the middle support member 330 between a first position shown in FIG. 6 corresponding to the retracted position of the slide-out section 130 of the RV 100 and a second position corresponding to the extended position of the slide-out section 130 of the RV 100.

The operating mechanism 390 can have components that are disposed within the storage compartment 170 of the RV 100, thereby allowing access to the operating mechanism 390 via the door 126 of the storage compartment 124. The storage compartment 124 is located below the frame 310 of the slide-out mechanism 300 in the embodiment of the present invention shown in FIGS. 1-11.

In one embodiment of the present invention as shown in FIGS. 1-11, the operating mechanism 390 is a pneumatic system which uses pneumatic pressure to controllably drive the middle arms 360 in either a first direction to extend the middle arms 360 or an opposite second direction to retract the middle arms 360. In this embodiment, the operating mechanism 390 includes a pair of hydraulic cylinders 394 for driving the shaft 392 in either an extension direction or a retraction direction, thereby allowing the middle arm 360 to slide within the middle support 330.

Each of the hydraulic cylinders 394 is connected to a first conduit 396 and a second conduit 396 for transferring a fluid such as air to and from the hydraulic cylinders 394 to extend and retract the rod 392. For example, as shown in FIG. 6, when air is supplied to the hydraulic cylinder 394 via the first conduit 396, the hydraulic cylinder 394 will move to the retracted position, and as shown in FIG. 7, when air is supplied to the hydraulic cylinder 394 via the second conduit 398, the hydraulic cylinder 394 will move to the extended position.

A bracket, such a right angle/L-shaped bracket, 338 is mounted toward the first end 331 of the middle support member 330. One of the hydraulic cylinders 394 is mounted onto each of the brackets 338 which act to support the cylinder 394 in a manner that permits the working components of the mechanism 300 to freely move. A coupling member 366 is associated with each of the middle arms 360 and acts to couple the shaft 392 to the middle arm 360. In one embodiment, the coupling member 366 is a plate that is mounted onto each middle arm 360 in an intermediate position between the first end 361 and the second end 362 of the middle arm 360. The shaft 392 is coupled to the plate 366 and serves as a piston that slides longitudinally within the hydraulic cylinder 394 and since the shaft 392 and plate 366 are coupled to one another, the movement of the piston is translated into movement of the middle arm 360. The plate 366 is positioned so that it can be accessed through the slot 336 in the middle support member 330 while the slide-out section 130 is in the extended or retracted positions. Thus, the ends of the slot 336 define the degree of travel of the plate 366. Preferably, the pneumatic source (air source) is one of the components that can be disposed within the storage compartment 170.

The hydraulic cylinders 390 are connected to an actuation mechanism (not shown) such as a button or a switch. The user operates the actuation mechanism to extend or retract the slide-out mechanism 300 via the operating mechanism 390. For example, when the slide-out sections 130 are in the retracted position and the user flips the switch, the hydraulic cylinders 394 are actuated and the shafts 392 extend and cause the two middle arms 360 to be driven in opposite directions relative to the frame which corresponds to the middle arms 360 either both being driven to an extended position or being driven to a retracted position. As will be described in greater detail below, the driving of the middle arms 360 is directly translated to movement of the slide-out sections 130 in the same direction that the middle arms 360 are driven. When the user flips the switch back to its original position, the hydraulic cylinders 394 operate in the opposite manner and the shafts 392 retract, thereby retracting the slide-out sections 130.

Alternatively, the operating mechanism 390 can include a rack-and-pinion mechanism, such as the rack-and-pinion mechanism shown in FIGS. 14-17 and as described below, to move the middle arms 360 between the extended and retracted positions, instead of the hydraulic cylinders 394.

It will also be appreciated that another mechanism, such as a stepper motor, may be used to controllably extend and retract the shafts 392 to cause the controlled movement of the slide-out sections 130.

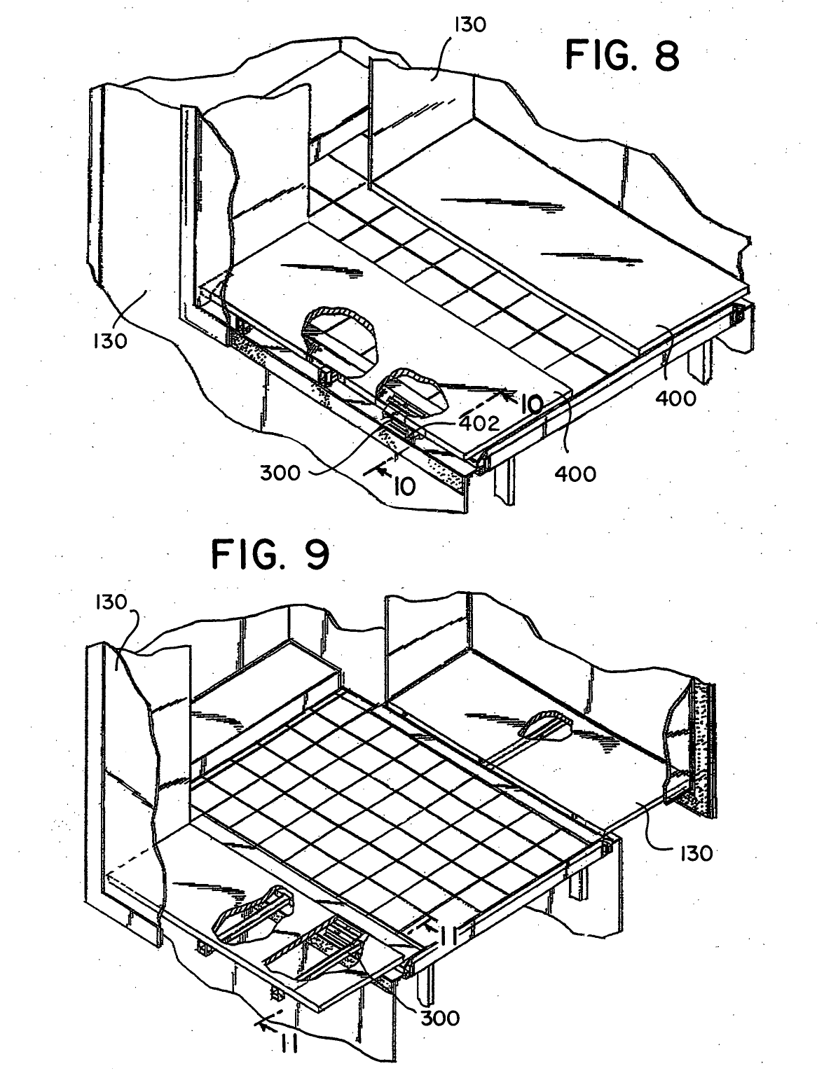

FIG. 8 is a perspective view of the interior space of the RV 100 with the slide-out section 130 in the retracted position, and FIG. 9 is a perspective view of the interior space of the RV 100 with the slide-out section 130 in the extended position. As can be seen, the present slide-out mechanism 300 is of a type that is commonly referred to as an above the floor chassis type mechanism since the slide-out sections 130 are initially disposed above the base floor of the vehicle 100 and mechanism 300 is incorporated into the chassis as opposed to being provided above the base floor. It will be appreciated that while the illustrated slide-out mechanism is of a dual type in that it contains two slide-out sections 130, only a single slide-out section 130 can be provided.

The protruding second ends 352, 362, 372 of the arms 350, 360, 370 are securely coupled to a corresponding movable floor section 400 that represents the floor of the slide-out section 130 and therefore, each slide-out section 130 is driven by urging of its floor portion. The arms 350, 360, 370 can be coupled to the floor section 400 using any number of techniques. For example and according to one embodiment, the arms 350, 360, 370 include openings 354, 364, 374 (shown in FIGS. 4 and 5) on the protruding second ends 352, 362, 372, respectively. A plurality of brackets 402 are provided to couple the second ends 352, 362, 372 to an edge of the floor section 400. The brackets 402 are securely attached to the arms 350, 360, 370 by using fasteners that are received through the openings 354, 364, 374 on the second ends 352, 362, 372 of the arms 350, 360, 370.

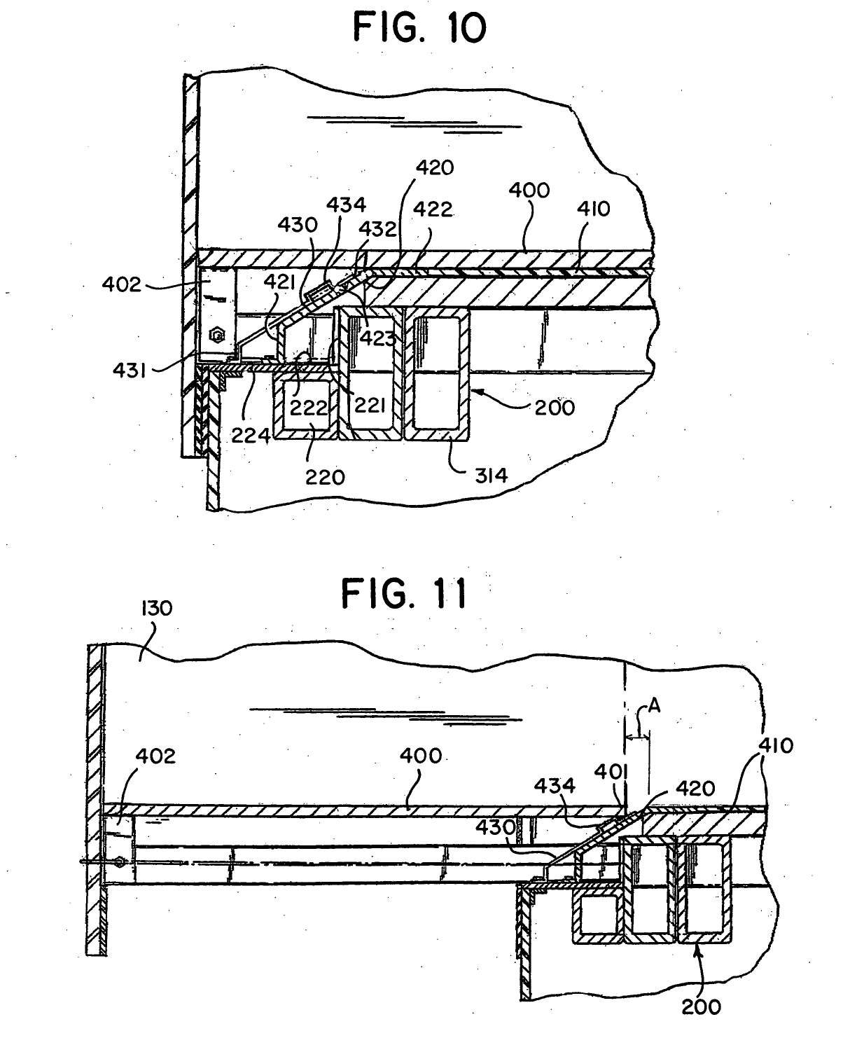

A stationary base floor section 410 is coupled to the chassis 200 and represents a support surface that extends across the chassis 200. The floor section 410 is coupled to the chassis 200 using any number of conventional techniques, including attaching the floor section 410 to the chassis 200 using conventional fasteners, such as screws, nails, etc. The stationary floor section 410 covers the major components of the mechanism 300, e.g., the six support members 320, 330, 340, and is made of a flat, durable flooring material such as plywood or tile. FIG. 10 is a cutaway view taken along the line 10-10 of FIG. 8 of a moveable floor section 400 when the slide-out section 130 is in the retracted position, and FIG. 11 is a cutaway view taken along the line 11-11 of FIG. 9 of the moveable floor section 400 when the slide-out section 130 is in the extended position.

A ledge 220 is formed in the chassis 200 at the left and right sides of the RV 100. The ledge 220 and the chassis 200 itself form a substantially L-shaped face with a vertical surface 221 and a horizontal surface 222. As described above, the chassis 200 includes notches 219 so that the support members 320, 330, 340 are slidably supported therein. The notches 219 allow the arms 350, 360, 370 and a portion of the support members 320, 330, 340 to extend therefrom. In the retracted position, the horizontal surface 222 of the ledge 220 supports the second ends 352, 362, 372 of the arms 350, 360, 370 that protrude outward from the second ends 322, 332, 342 of the support members 320, 330, 340. In the extended position, the horizontal surface 222 of the ledge 220 supports the portion of the arms 350, 360, 370 that overlap thereon. A supporting plate 224 is provided on the vertical surface 221 of the ledge 220 to extend past the sides of the chassis 200. However, alternatively, instead of providing the supporting plate 224, the sides of the chassis 200 can be formed to extend farther than as shown on FIG. 10.

At least one panel 420 covers a portion of the chassis 200 including the ledge 220, a portion of the supporting plate 224, and the top surface of the sides of the chassis 200 that are welded to the side frame members 314. The panel 420 has a vertical surface 421 positioned above the supporting plate 224, a horizontal surface 422 aligned flush with the stationary floor section 410, and a sloped surface 423 joining the vertical and horizontal surfaces 421, 422 of the panel 420. The sloped surface 423 of the panel 420 inclines upward toward the center of the RV 100 so that the horizontal surface 422 of the panel 420 is aligned flush with the stationary floor section 410. The panel 420 thus provides a sloped edge finishing for the floor section 410 and provides a smooth transition to the ledge 220 so that the peripheral edges of the floor section 410 are not exposed.

At least one ramped support 430 is provided proximate to the front support member 320 and the rear support member 340. Preferably, there are two ramped supports 430 that are spaced apart one another to facilitate the sliding action of the slide-out section 130 and to locate the slide-out section 130 when it is extended. The ramped support 430 includes a bottom edge 431 and a top edge 432. The bottom edge 431 of the ramped support 430 is supported by the supporting plate 224, and the top edge 432 of the ramped support 430 overlies the sloped surface 423 of the panel 420.

One moveable floor section 400 is included for each slide-out section 130. Two moveable floor sections 400 are thus included in the illustrated dual slide-out mechanism 300. For sake of brevity and clarity, the following description is directed to the actuation and movements of a single moveable floor section 400. It is understood, however, that this description is equally applicable for the other moveable floor section 400 in a dual slide-out mechanism 300.

The moveable floor section 400 includes one edge attached to the brackets 402 and an opposite edge which is a free edge 401. As described above, the brackets 402 attach the moveable floor section 400 on one side of the RV 100 to the protruding second ends 352, 362, 372 of the three arms 350, 360, 370. Therefore, when the operating mechanism 390 extends and retracts the middle arm 360, the movement of the middle arm 360 is translated to the front and rear arms 350, 370 via the moveable floor section 400, thereby ensuring synchronization of the three arms 350, 360, 370 as they move in and out of the support members 320, 330, 340. In other words, while the middle arms 360 are the only arms that are positively driven, the other arms 350, 370 are passively driven since all of the arms 350, 360, 370 are connected to a common member, namely the floor section 400.

The mechanism 300 of the present invention provides a flush floor between the stationary floor section 410 and the moveable floor sections 400 when the slide-out sections 130 are in the extended positions to provide a nice smooth, transition free enlarged room in the vehicle 100. When the moveable floor section 400 is in the retracted position, it lies on top of the stationary floor section 410. The free edges 401 of the floor sections 400 face another and are in close proximate relation to one another, with a small gap being formed between the free edges 401. After the moveable floor section 400 starts to extend outward via the movement of the arms 350, 360, 370, the free edge 401 of the moveable floor section 400 lowers as it passes over the sloped surface 423 of the panel 420 and the sloped surface of the ramped supports 430. At the extended position, the upper surface of the moveable floor section 400 is aligned essentially flush with the upper surface of the stationary floor section 410, and essentially the entire moveable floor section lies above the brackets 402, the arms 350, 360, 370, the sloped surface 423 of the panel 420, and the sloped surface of the ramped supports 430.

At the extended position, any height differential that exists due to the support of the brackets 402 underneath the moveable floor section 400 is offset by the deflection of the second ends 352, 362, 372 of the arms 350, 360, 370. The weight of the slide-out section 130 on the cantilevered arms 350, 360, 370 allow the moveable floor section 400 to deflect and be substantially horizontal, resulting in the floor sections 400, 410 being substantially flush and planar with one another.

Ramp support 430 can include a feature 434 that serves as a locator or stop that limits the movement of the moveable floor section 400 as it is extended. The feature 434 is preferably an integral feature and represents an elevated section of the ramp support 430 as compared to the surrounding sections. The feature 434 is formed on the beveled section of the ramp support 430. The feature 434 functions as a stop since it limits the degree of travel of the floor section 400 as the floor section 400 travels down the ramp support 430. The illustrated feature 434 represents a bent section of the ramp support 430 that can serve as a catch or stop. The feature 434 is located along the ramp support 430 at a location where the floor section 400 will be flush with the floor section 410 when the floor section 400 seats against the feature 434. In other words, the feature 434 is positioned such that it limits the end of travel of the floor section 400 as the slide-out section 130 is being extended from the base floor section 410.

There may be a slight gap A (shown in FIG. 11) between the end of the moveable floor section 400 and the edge of the sloped sections of the panel 420 and/or the ramped support 430. However, in an embodiment of the present invention, a carpet (not shown) can be used to cover the moveable floor section 400 and the stationary floor section 410, which would also cover this gap. The carpet can be rolled over the moveable floor section 400 and the stationary floor section 410 after the slide-out sections 130 are extended to their extended positions.

When the moveable floor sections 400 are in the process of being retracted, the panel 420 and the ramped support 430 allow the moveable floor sections 400 to slide back up to their original height. At the final retracted position, the moveable floor sections 400 have returned to their original positions overlapping the stationary floor section 410.

In the embodiment shown in FIGS. 1-11, the frame 310 is fixed to the chassis 200 by a known method such as welding. However, in an alternate embodiment of the present invention, the frame 310 is not included. In this alternate embodiment, the support members 320, 330, 340 are fixed directly to the chassis 200. The stubs 318, which are provided on the side frame members 314 in the embodiment shown in FIGS. 1-11, can be provided on the chassis 200 in the alternate embodiment to mate with the first ends 321, 341 of the front and rear support members 320, 340. The middle support members 330 are fixed directly to the chassis 200.

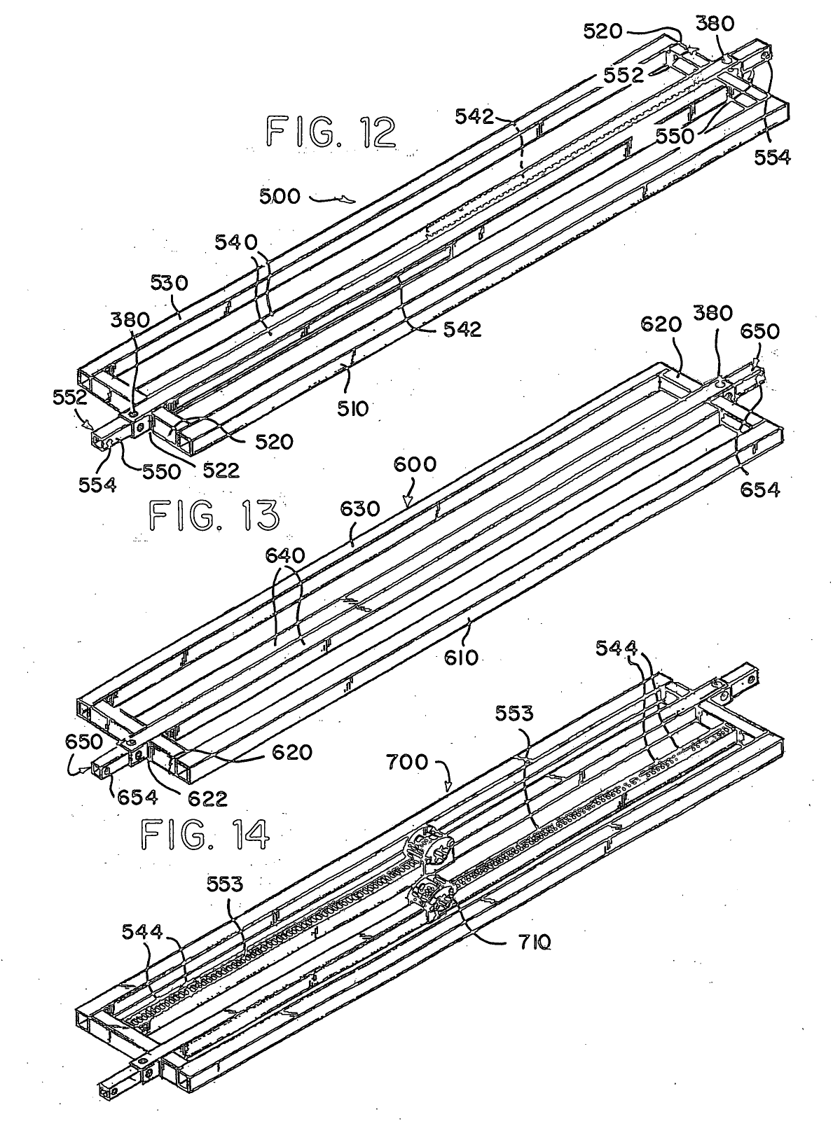

FIG. 12 shows another embodiment of the present invention in which the slide-out mechanism 300 is formed of at least one and preferably two or more frame sub assemblies, including a center support sub-assembly 500. The center support sub-assembly 500 is an alternative to the frame 300 and the support members 320, 330, 340 of the embodiment shown in FIGS. 1-11. The exemplary center support sub-assembly 500 has a rectangular shape and is formed of a front member 510, side members 520, and a rear member 530.

The center support sub-assembly 500 is positioned approximately midway between the front and rear sides of the upper deck portion 210 of the chassis 200. One end of the support members 540 is fixed to one of the side members 520, and the other end is slidably supported within notches 522 in the opposite side member 520 and the notches 219 in the chassis 200. The side frame members 520 are attached to the chassis 200.

Telescoping arms 550 are slidably supported within the support members 540. The support members 540 and the arms 550 of the center support sub-assembly 500 are substantially identical in size and function to the middle support member 330 and the middle arm 360 of the embodiment shown in FIGS. 1-11. Accordingly, each of the arms 550 is driven by the operating mechanism 390, e.g., hydraulic cylinders 394, and the support members 540 permit access to the arms 550 via longitudinal slots 542 (rectangular slots). Wear tabs 380 can also be included, as shown in FIG. 12, positioned similarly to the embodiment shown in FIGS. 1-11.

Thus, the center support sub-assembly 500 shown in FIG. 12 can be mounted onto the chassis 200 as described above so that there is a single arm 550 that supports each slide-out section 130. The arms 550 include a first end 551, a second end 552, and an opening 554 at the second end 552 for attaching the bracket 402 (FIG. 10).

In the embodiment described above, the chassis 200 is provided with a single notch 219 on each side of the chassis 200, corresponding to each of the support members 540 of the center support sub-assembly 500. The chassis 200 can be attached to the sub-assembly by welding along the support members 520.

In another embodiment of the present invention, the chassis 200 can be provided with additional notches 219 to slidably support one or more passive support sub-assemblies 600 (FIG. 13) so that the center support sub-assembly 500 and the one or more passive support sub-assemblies 600 are spaced apart along the length of the chassis 200. In an exemplary embodiment, two passive support sub-assemblies 600 are provided toward the front and the rear of the upper deck portion 210 of the chassis 200.

FIG. 13 is a perspective view of the passive support sub-assembly 600 of an alternate embodiment of the present invention. The passive support sub-assembly 600 is similar to the center support sub-assembly 500 except that the passive support sub-assembly 600 is not connected to the operating mechanism 390 and does not include the slot 542. The passive support sub-assembly 600 has a rectangular shape and is formed of a front member 610, side members 620, and a rear member 630. One end of the support members 640 is fixed to one of the side members 620, and the other end is slidably supported within notches 622 in the opposite side member 620 and the notches 219 in the chassis 200.

Telescoping arms 650 are slidably supported in the support members 640 and include an opening 654 for attaching the bracket 402, as described in the embodiment shown in FIGS. 1-11. The arms 650 of the passive support sub-assembly 600 are substantially identical in size and function to the front and rear arms 350, 370 of the embodiment shown in FIGS. 1-11. Wear tabs 380 can also be included, as shown in FIG. 13, positioned similarly to the embodiment shown in FIGS. 1-11. The arms 650 are thus passive since they are not positively driven by the drive mechanism.

Preferably, the sub-assemblies have a synchronizing feature incorporated as a part thereof to ensure that the telescoping arms 550, 650 are synchronized as they are extended and retracted. For example, the synchronizing feature can be in the form of a member that links adjacent telescoping arms 550, 650 to one another. In other words, a cross structure, e.g., an elongated member, such as a tube or the like, can be provided between adjacent arms 550, 650 with the ends of the elongated member being securely attached to distal ends of the adjacent arms 550, 650. The elongated synchronizing members are located with respect to the distal ends such that when the arms 550, 650 are in their retracted positions, the elongated synchronizing members are adjacent side members of the chassis frame. In other words, the elongated synchronizing members limit the degree that the arms 550, 650 can be retracted into their respective support members since the synchronizing members contact the side members of the chassis frame. The synchronizing members serve to ensure that the arms move in a synchronized manner as they are extended and retracted since the synchronizing members link together all of the arms associated with one slide-out section and therefore, when the one drive arm is driven, the other arms are passively driven at the same time and speed since the synchronizing members link all the arms together. This ensures that the slide-out section is moved in a smooth, uniform manner.

The embodiments shown in FIGS. 12 and 13 can be used with an operating mechanism 390 in the form of hydraulic cylinders 394. Alternatively, the operating mechanism 390 can include a rack-and-pinion mechanism 700 with a gear mechanism 710 to move the middle arms 550 between the extended and retracted positions.

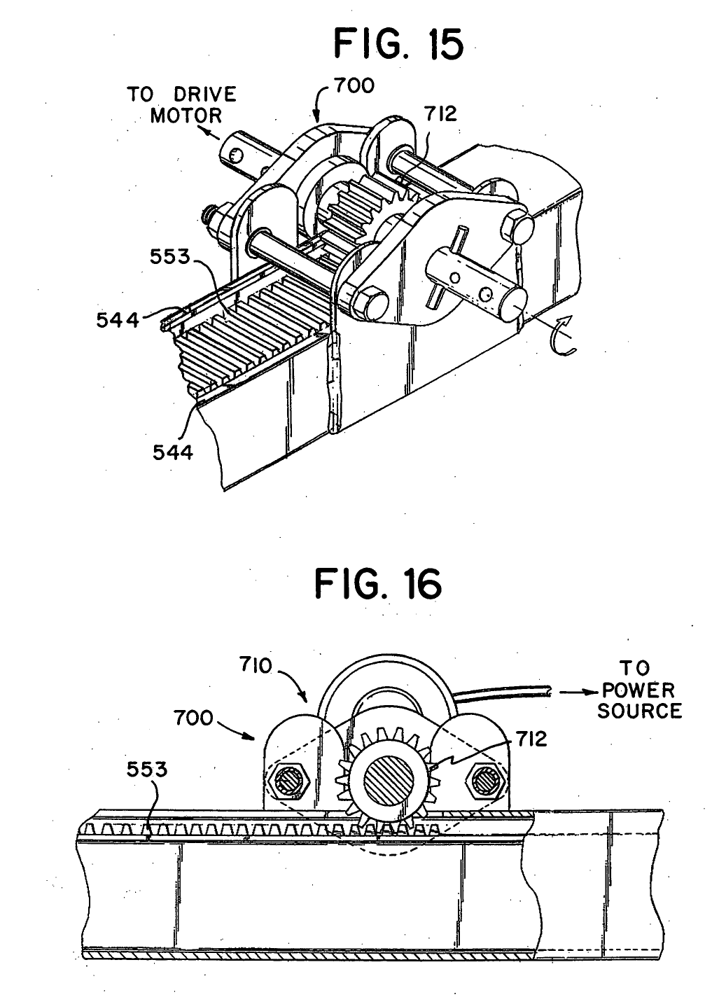

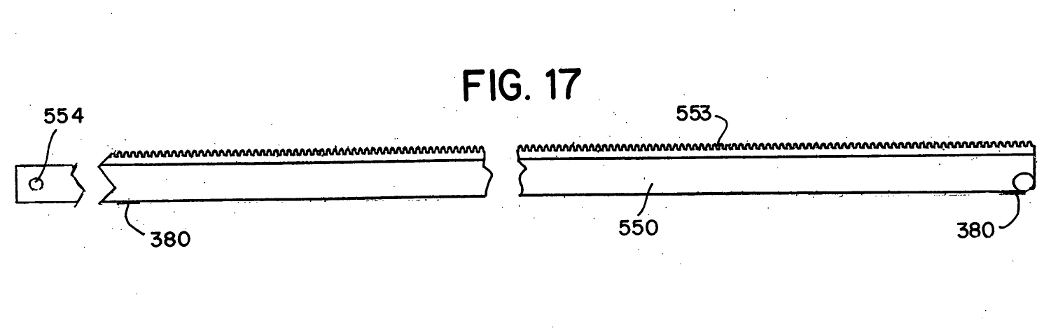

FIG. 14 is a perspective view of the center support sub-assembly 500 and the rack-and-pinion mechanism 700; FIG. 15 is a perspective view of the gear mechanism 710; FIG. 16 is a side view of the center support sub-assembly 500 and the rack-and-pinion mechanism 700 of FIG. 14; and FIG. 17 is a side view of the middle arm 550 and the middle support member 540 of the center support sub-assembly 500 of FIGS. 15 and 16.

Teeth 553 are provided along the top surface of the arms 550 of the center support sub-assembly 500 from the first end 551 to approximately the middle of the arm 550. The teeth 553 mate with a gear 712 of the gear mechanism 710, as shown in FIG. 16.

The support members 540 of the center support sub-assembly 500 of this embodiment are modified so that they have a longitudinal opening at the top surface that extends along the longitudinal length of the support member 540. The opening forms lips 544 that extend over the tops of the arms 550. The lips 544 are short enough to allow the gear mechanism 710 to contact the teeth 553 on the top of the arms 550. The longitudinal opening can extend substantially the entire length of the support member 540 or it can extend less than the entire length, such as ½ of the length, as shown.

The gear mechanism 710 is fixed in position with respect to the corresponding support member 550 and is driven by a motor (not shown). As the gear 712 in the gear mechanism 710 is rotated in one direction via the motor, the corresponding arm 550 is extended. Accordingly, as the gear 712 in the gear mechanism 710 is rotated in the opposite direction, the corresponding arm 550 is retracted.

The present invention provides a dual slide-out mechanism 300 that spans the width of the RV 100 from the left side to the right side so that the RV 100 can expand on the left and/or right sides. This dual slide-out mechanism 300 includes two slide-out sections 130. The present invention, however, is not limited to a dual slide-out mechanism 300 and can be mounted as a single slide-out mechanism in either the left or right side of the RV 100, thereby providing one slide-out section.

Preferably, the inward length of the side walls 134 of the slide-out section 130 defines the limit of expansion of the slide-out section 130. In an embodiment of the present invention, the slide-out section 130 may be occupied when in the retracted position, and a balance is achieved by making the inward length as large as it can be without unduly interfering with the use of the RV 100 interior during transit. Typically, the upper deck portion of the RV 100 is used as a living room or seating area; and, therefore, the slide-out section 130 can be incorporated into the living room area of the upper deck portion of the RV 100 as a means for increasing the interior living space. Furniture, such as a chair and/or an entertainment center, can be fixed to one or both of the moveable floor sections 400 to slide out with the slide-out section 130, thereby increasing the amount of available space toward the center of the RV 100.

As can be seen in the foregoing description and drawings, the dual slide-out mechanism 300 can be constructed as a single slide-out mechanism for incorporating a single slide-out section 130 in the left or right side of the RV 100. A single slide-out mechanism includes a single set of support members, which includes one front support member 320, one middle support member 330, and one rear support member 340, and a single set of arms, which includes one front arm 350, one middle arm 360, and one rear arm 370.

The following example is intended to illustrate the construction and the advantages of the present invention more fully without limiting its scope, since numerous modifications and variations will be apparent to those skilled in the art.

### EXAMPLE

In one example of the present invention, the frame 310 is constructed to have a length of 76″ from the front surface of the front frame member 312 to the rear surface of the rear frame member 316 and 84″ wide from the outward facing surfaces of the side frame members 314. The support members 320, 330, 340 and arms 350, 360, 370 have a square-shaped cross section. The outer dimensions of the support members 320, 330, 340 are approximately 2″×2″, and the outer dimensions of the arms 350, 360, 370 are approximately 1½″×1½″. The middle support members 330 are separated from the front and rear support members 320, 340 by approximately 30″-32″.

Openings (not shown) for mounting the plate 366 in one wall of the middle arm 360 are positioned approximately 39¼″ in the longitudinal direction from the second end 362 of the middle arm 360 that attaches to the brackets 402. These holes are aligned with the openings (not shown) in the plate 366 for mounting the shaft 392 of the hydraulic cylinder 394.

In the extended state, the second ends 352, 362, 372 of the arms 350, 360, 370 are extended approximately 24″-36″ between the extended and retracted states, and the slots 336 in the middle support members 330 are approximately 36″ long.

Having described embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A slide-out mechanism for a vehicle for extending and retracting at least one slide-out section relative to a frame of the vehicle, the slide-out section having a floor and the slide-out mechanism being configured for incorporation into a chassis in the vehicle and comprises:
a frame;
a plurality of movable arms supported by the frame and having ends that are securely coupled to the floor of the slide-out section, wherein at least one of the movable arms is a drive arm; and
drive means coupled to an intermediate section of the drive arm for driving the drive arm in a first direction for extending the movable arm outwardly from the frame resulting in the slide-out section being driven to an extended position and a second direction for retracting the movable arm toward the frame resulting in the slide-out section being driven to a retracted position.

2. The mechanism of claim 1, wherein the frame is a box frame with opposing sides of the frame each having notches formed therein at spaced locations to receive each of the movable arms.

3. The mechanism of claim 1, wherein the frame includes:
a plurality of hollow support members that receive the plurality of arms such that each arm can extend beyond the respective support member and away from the frame, wherein the hollow support member that receives the drive arm includes a slot formed along one face thereof to permit free access into an interior of the support member and to the drive arm disposed therein.

4. The mechanism of claim 3, wherein first ends of the hollow support members are coupled to sides of the frame such that each support member is permitted a limited degree of travel relative to the sides of the frame.

5. The mechanism of claim 4, wherein the sides of the frame have spaced at least one stub that receives at least one of the first ends of the hollow support members and a length of the stub defining the degree of travel of the support member.

6. The mechanism of claim 1, wherein the drive means comprises a pneumatic device having a moveable piston that has a free end coupled to the drive arm and is moveable between an extended position and a retracted position, the extended position of the piston corresponding to the extended position of the arms, while the retracted position of the piston corresponds to the retracted position of the arms.

7. The mechanism of claim 1, wherein the drive means is coupled to an intermediate section of a second drive arm for driving the second drive arm in the second direction for extending the movable arm outwardly from the frame resulting in a second slide-out section being driven to an extended position and the first direction for retracting the movable arm toward the frame resulting in the second slide-out section being driven to a retracted position.

8. The mechanism of claim 1, wherein the support members comprise at least one hollow middle support member, at least one hollow front support member disposed in front of the middle support member, and at least one hollow rear support member disposed to the rear of the middle support member, wherein:
the at least one middle support member is stationary with respect to the frame,
the at least one front support member is movable with respect to the frame, and
the at least one rear support member is movable with respect to the frame.

9. The mechanism of claim 8, wherein the at least one front support member and the at least one rear support member are movable with respect to the frame via stubs disposed on the sides of the frame spaced to receive first ends of the front and rear support members and a length of the stub defines the degree of travel of the front and rear support members.

10. The mechanism of claim 1, wherein:
the floor of the slide-out section overlies a stationary floor section mounted onto the chassis;
the floor of the slide-out section is supported by and moves with the drive arm;
as the slide-out section moves between the retracted and extended positions, at least a portion of the floor of the slide-out section slides over a ramp at least partially mounted on the chassis; and
when the slide-out section is in the extended position, the floor of the slide-out section is aligned flush with the stationary floor section.

11. The mechanism of claim 1, wherein the drive means comprises a rack-and-pinion device coupled to the drive arm to move the drive arm between an extended position and a retracted position.

12. The mechanism of claim 1, wherein the slide-out section is incorporated into an upper deck of the vehicle, the slide-out mechanism is configured for incorporation into the chassis in the upper deck of the vehicle, and at least a portion of the drive means is housed in a storage compartment in the vehicle below the upper deck.

13. The mechanism of claim 2, wherein the notches in the frame are aligned with notches in opposing sides of the chassis to receive each of the moveable arms.

14. An expandable room structure for a vehicle comprising a chassis, the structure comprising:
a first room portion and at least one second room portion, each portion having a floor;
the second room portion being mounted so as to be moveable with respect to the first room portion between extended and retracted positions, the floor of the second room portion being disposed above the floor of the first room portion in the retracted position,
at least one hollow middle support member, at least one hollow front support member disposed in front of the middle support member, and at least one hollow rear support member disposed to the rear of the middle support member;
the support members mounted under the first room portion;
at least one middle arm, at least one front arm disposed in front of the middle arm, and at least one rear arm disposed to the rear of the middle arm;
the arms being mounted under the second room portion and being telescopically mounted inside the support members; and
the middle arm being a drive arm and being connected to a drive means for moving the middle arm along the longitudinal length of the middle support member, thereby moving the second room portion between the extended and retracted positions.

15. The structure of claim 14, wherein the middle support members are mounted onto a box frame with opposing sides of the frame each having notches formed therein at spaced locations to receive each of the support members.

16. The structure of claim 15, wherein each of the arms can extend beyond the respective support member and away from the frame, wherein the support member that receives the middle arm includes a slot formed along one face thereof to permit free access into an interior of the support member and to the middle arm disposed therein.

17. The structure of claim 16, wherein first ends of the hollow support members are coupled to sides of the frame such that each support member is permitted a limited degree of travel relative to the sides of the frame.

18. The structure of claim 17, wherein the sides of the frame have at least one spaced stub that received at least one of the first ends of the hollow support members and a length of the stub defining the degree of travel of the support member.

19. The structure of claim 14, wherein the drive means comprises a pneumatic device having a moveable piston that has a free end coupled to the middle arm and is moveable between an extended position and a retracted position, the extended position of the piston corresponding to the extended position of the arms, while the retracted position of the piston corresponds to the retracted position of the arms.

20. The structure of claim 15, wherein the drive means is coupled to an intermediate section of the middle arm for driving the middle arm in a first direction for extending the arm outwardly from the frame resulting in the second room portion being driven to the extended position and a second direction for retracting the arm toward the frame resulting in the second room portion being driven to the retracted position; and
the drive means is coupled to an intermediate section of a second middle arm for driving the second middle arm in the second direction for extending the arm outwardly from the frame resulting in an other second room portion being driven to an extended position and the first direction for retracting the arm toward the frame resulting in the other second room portion being driven to a retracted position.

21. The structure of claim 15, wherein:
the at least one middle support member is stationary with respect to the frame,
the at least one front support member is movable with respect to the frame, and
the at least one rear support member is movable with respect to the frame.

22. The mechanism of claim 21, wherein the at least one front support member and the at least one rear support member are movable with respect to the frame via stubs disposed on the sides of the frame spaced to receive first ends of the front and rear support members and a length of the stub defines the degree of travel of the front and rear support members.

23. The structure of claim 14, wherein:
the floor the first room portion is mounted onto the chassis;
the floor of the second room portion is supported by and moves with the middle arm;
as the second room portion moves between the retracted and extended positions, at least a portion of the floor of the second room portion slides over a ramp at least partially mounted on the chassis; and
when the second room portion is in the extended position, the floor of the second room portion is aligned flush with the floor of the first room portion.

24. The structure of claim 14, wherein the drive means comprises a rack-and-pinion device coupled to the middle arm to move the middle arm between an extended position and a retracted position.

25. The structure of claim 14, wherein the second room portion is incorporated into an upper deck of the vehicle and at least a portion of the drive means is housed in a storage compartment in the vehicle below the upper deck.

26. The structure of claim 15, wherein the notches in the frame are aligned with notches in opposing sides of the chassis to receive each of the support members.

27. A vehicle having a slide out room structure therein to selectively expand the internal accommodation of the vehicle, the room structure comprising a first portion and a second portion slidably nested within the first portion when the room structure is in a retracted position, each of the first and second portions having a roof section, side, and end wall sections and a floor section, the floor section of the second portion being disposed above the floor section of the first portion when the room structure is in the retracted position, and including a slide-out mechanism for moving the second portion relative to the first portion to define an expanded position of the room structure wherein the floor section of the first portion and the floor section of the second portion are disposed on the same horizontal plane, the slide-out mechanism comprising:
at least one hollow middle support member, at least one hollow front support member disposed in front of the middle support member, and at least one hollow rear support member disposed to the rear of the middle support member;
the support members mounted under the first room portion;
at least one middle arm, at least one front arm disposed in front of the middle arm, and at least one rear arm disposed to the rear of the middle arm;
the arms being mounted under the second room portion and being telescopically mounted inside the support members; and
the middle arm being a drive arm and being connected to a drive means for moving the middle arm along the longitudinal length of the middle support member, thereby moving the second room portion between the extended and retracted positions.

28. A fifth wheel type recreational vehicle including a main cabin portion and an upper deck portion having a chassis that supports a stationary base floor and a slide-out section that includes a floor and that selectively extends from an exterior surface when actuated for increasing an interior space of the upper deck portion, the vehicle comprising:
a slide-out mechanism for selectively moving the slide-out section between a retracted position and an extended position, the mechanism being nested within receiving features that are formed in the chassis so as to couple the mechanism to the chassis, the mechanism being disposed underneath the stationary base floor and including:
a frame that is securely attached to the chassis;
at least three hollow support members that have first ends that are securely coupled to the frame and second ends that are nested within the receiving features of the chassis, at least one of the hollow support members having an elongated slot formed in a face thereof;
at least three arms that are slidably received within the hollow support members with each having one end thereof that is securely connected to the overlying floor of the slide-out section such that movement of the arm is translated into movement of the arms is translated into movement of the floor of the slide-out section, wherein at least of the arms is a drive arm;
a drive device that is selectively operable and includes an elongated drive piston that extends through the elongated slot and is coupled at one end to a medial region of the drive arm; wherein extension of the drive piston is translated into extension of the drive arm outwardly beyond the chassis resulting in the slide-out section moving from a retracted position where it overlies the stationary floor to an extended position where the floor of the slide-out section is substantially flush with the stationary floor and when the drive piston is retracted, the drive arm is likewise retracted causing the slide-out section to be drawn back to the retracted position; and
a ramp structure that cooperates with the stationary floor and is coupled to the chassis to permit the floor of the slide-out section to ride down the ramp structure as the floor is moved from the retracted position to the extended position and vice versa when the floor is driven back to the retracted position.

29. The vehicle of claim 28, wherein the drive device comprises a pneumatic device and the one end of the drive piston is coupled to the medial region of the drive arm with a plate member that extends through the elongated slot.

30. The vehicle of claim 28, wherein a length of the elongated slot defines a maximum length of travel of the drive arm.

31. The vehicle of claim 28, wherein the receiving features of the chassis are a plurality of notches that receive end sections of the support members in a nested manner.

32. The vehicle of claim 28, wherein there are two slide-out sections that extend in opposite directions relative to the frame with each slide-out section having at least three support members and at least three arms that are associated therewith and coupled thereto for driving the slide-out section between the retracted and extended positions, wherein each slide-out section includes one drive device such that actuation of the drive devices results in synchronized movement of the slide-out sections, the pistons of the drive devices being driven in opposite directions during the synchronized movement to cause the slide-out sections to be driven toward the same position.

33. The vehicle of claim 32, wherein at least two of the three arms are passive arms in that the are free from being directly driven; however, the at least two arms move in the same direction as the drive arm due to all three of the arms being attached to the slide-out section.

34. The vehicle of claim 28, wherein the receiving features of the chassis are in the form of spaced slots formed therein and the frame of the slide out section includes complementary slots that are substantially aligned with the spaced slots of the chassis to permit the support arms to be disposed within both sets of slots when the frame is securely attached to the chassis.

35. The mechanism of claim 11, wherein the rack-and-pinion device is fixed in positioned in relation to the frame and comprises a gear that mates with teeth formed on a surface of the drive arm.

36. The structure of claim 24, wherein the rack-and-pinion device is fixed in positioned in relation to the middle support member and comprises a gear that mates with teeth formed on a surface of the drive arm.

37. A slide-out mechanism for a vehicle for extending and retracting at least one slide-out section relative to a frame of the vehicle, the slide-out section having a floor and the slide-out mechanism being configured for incorporation into a chassis in the vehicle and comprises:
a frame;
at least one moveable drive arm that is supported by the frame and has an end that is securely coupled to the floor of the slide-out section, wherein a portion of one face of the drive arm includes a first drive feature formed as a part thereof; and
a drive device for driving the at least one moveable drive arm between a retracted position and an extended position, the drive device having a second drive feature that mates with the first drive feature such that when the drive device is operated in a first manner, the drive arm is driven to the extended position and when the drive device is operated in a second manner, the drive arm is driven to the retracted position.

38. The mechanism of claim 37, wherein the drive device comprises a gear mechanism that is operatively coupled to a motor, the gear mechanism having a gear which acts as the second drive feature and is mounted to a rotatable shaft that is operatively coupled to the motor wherein in the operation of the drive device in the first manner, the gear is rotated in a first direction and when the drive device is operated in the second manner, the gear is rotated in a second direction.

39. The mechanism of claim 38, wherein the first drive feature is a plurality of first teeth formed along an upper surface of a selected length of the at least one drive arm, the gear having complementary second teeth that intermesh with the first teeth.

40. The mechanism of claim 37, wherein the gear mechanism is mounted in a stationary position relative to the at least one drive arm.

41. The mechanism of claim 37, further including:
at least one hollow support member that receives the at least one drive arm such that the at least one drive arm slides within the at least one hollow support member between the retracted and extended positions.

42. The mechanism of claim 41, wherein the at least one hollow support member has an upper face that is substantially open and is defined in part by a pair of inwardly curved lips defined at upper sections of a pair of side walls, the lips being spaced a part sufficiently to permit the first drive feature to be received therebetween.
